(19) United States
(12) Patent Application Publication
(10) Pub. No.: US 2014/0204052 A1
(43) Pub. Date: Jul. 24, 2014

(54) SYSTEM AND METHOD USING DETECTABLE SIGNALS OF PANEL FOR DATA COMMUNICATION

(71) Applicant: Generalplus Technology Inc., Hsinchu City (TW)

(72) Inventors: Chih-Hao LIANG, Hsinchu City (TW); Cheng-Chiang LIU, Hsinchu County (TW)

(21) Appl. No.: 13/925,875

(22) Filed: Jun. 25, 2013

(30) Foreign Application Priority Data
Jan. 24, 2013 (TW) 102102624

(51) Int. Cl. G06F 3/044

(52) U.S. Cl. CPC G06F 3/044
USPC 345/174

(57) ABSTRACT

A system using detectable signals of panel for data communication includes the panel, at least one detectable signal detector, and a control unit. The panel has a surface for displaying an image. At least one area of the surface is used to display variation of a detectable signal. The at least one detectable signal detector is coupled to the at least one area for detecting the variation of the detectable signal in the at least one area and producing a corresponding detection signal. The control unit is connected to the at least one detectable signal detector for receiving the detection signal. Thus, the control unit can receive the data sent from the at least one area.

### BACKGROUND OF THE INVENTION

1. Field of the Invention

The present invention relates to the technical field of display panels and, more particularly, to a system and method using detectable signals of panel for data communication.

2. Description of Related Art

Current consumer electronics are typically provided with a touchpad as one of the input devices. To meet with the requirements of being light, thin, short, and small, a touchpad and a panel are combined into a touch panel for a user to conveniently input data.

Upon the sensing principle, touchpads are divided into four types: resistive type, capacitive type, surface acoustic wave type, and optics type. The operation principle of touch panels is to sense a voltage, a current, an acoustic wave or an infrared when a finger or other medium touches on a touch screen, so as to detect the coordinates of touching points. For example, a resistive touch panel uses the voltage difference between upper and lower electrodes to determine the location where a force is applied, to thereby detect the touching point. A capacitive touch panel uses the current or the voltage originated from capacitance changes in a static electricity combination of transparent electrodes in row and column with human body to detect the touching coordinate.

FIG. 1 is a schematic view of driving a typical capacitive touch panel, which is an nxm touch panel 120, where n, m are each an integer greater than one. As shown in FIG. 1, a controller 110 sequentially generates a driving signal Vin at the conductor lines X1-Xn in one direction for coupling charges into the conductor lines Y1-Ym through mutual capacitance between the conductor lines X1-Xn and the conductor lines Y1-Ym in the other direction. The controller 110 has m sensors (not shown) to measure the charges for further generating the voltage signals.

FIG. 2 schematically illustrates the structure of a typical capacitive touch panel. As shown in FIGS. 1 and 2, the conductor lines X1-Xn and Y1-Ym are comprised of diamond sensing conductors 121-124, and the mutual capacitance 201-204 is generated between the diamond sensing conductors 121-124. Instead of being physical capacitors, the mutual capacitance 201-204 is mutually induced by the diamond sensing conductors 121-124.

FIGS. 3 and 4 are schematic views of a typical capacitive touch panel without and with an approaching finger. As shown in FIG. 3, when there is no grounded conductor or finger approaching to the touch panel 120, the mutual capacitance C_{(x,y)} equals to Cm0. As shown in FIG. 4, when a grounded conductor or a finger approaches to the touch panel, the electrical power lines between the conductor lines X1-Xn and Y1-Ym are interfered and reduced, so as to affect the value of the mutual capacitance, which is assumed to be, for example, Cm1 when there is a touch. The sensors make use of the change of the mutual capacitance to measure the charges and further generate the voltage signals.

With reference to FIGS. 1, 3, and 4, when the finger approaches to an area comprised of the sensing conductors 121-124 of the touch panel, the controller 110 generates the driving signal Vin on the conductor line X2. At first, there is no finger or grounded conductor at the intersection of the conductor lines X2 and Y1, so that the controller 110 can detect a high potential. Next, when there is a finger or a grounded conductor at the intersection of the conductor lines X2 and Y2, a virtual grounded signal at the intersection is detected to thereby reduce the power lines. In this case, the controller 110 can detect a low potential, i.e., the controller 110 can detect a touch point positioned at the intersection of the conductor lines X2 and Y2. It is noted that, instead of directly touching the conductor lines, the finger or grounded conductor touches the conductor lines via a cover of lens. Similarly, when there is no finger or grounded conductor at the intersection of the conductor lines X2 and Y3, the controller 110 can detect a high potential. Accordingly, multiple touch points on the touch panel can be detected.

With popular smart phones and tablet PCs, they are mostly equipped with a multi-touch screen. In addition, a smart phone or tablet PC is always connected with the peripherals through the interfaces of USB, SD, Bluetooth, and the like. However, the handheld devices with a touch screen do not use the features of the touch screen to transfer data. In addition, a typical liquid crystal display (LCD) panel and cathode ray tube (CRT) screen do not have the techniques associated with data transfer using the screen features. Therefore, it is desirable to provide an improved handheld system with a touch screen to mitigate and/or obviate the afore-mentioned problems.

### SUMMARY OF THE INVENTION

The object of the present invention is to provide a system and method using detectable signals of panel for data communication.

In one aspect of the present invention, there is provided a system using detectable signals of panel for data communication, which includes the panel, at least one detectable signal detector, and a control unit. The panel has a surface for displaying an image. At least one area of the surface is used to display variation of a detectable signal. The at least one detectable signal detector is coupled to the at least one area for detecting the variation of the detectable signal in the at least one area and producing a corresponding detection signal. The control unit is connected to the at least one detectable signal detector for receiving the detection signal which represents a data state. Thus, the control unit can obtain the data state sent from the at least one area.

In another aspect of the present invention, there is provided a method using detectable signals of panel for data communication applied in a panel including a surface for displaying an image, at least one detectable signal detector coupled to at least one area of the surface, and a control unit connected to the at least one detectable signal detector. The method includes the steps of: (A) displaying variation of a detectable signal in the at least one area of the surface; (B) using the at least one detectable signal detector to detect the variation of the detectable signal in the at least one area, thereby producing a corresponding detection signal; and (C) using the control unit to receive the detection signal which represents a corresponding data state, thereby obtaining the data state sent from the at least one area.

Other objects, advantages, and novel features of the invention will become more apparent from the following detailed description when taken in conjunction with the accompanying drawings.

### BRIEF DESCRIPTION OF THE DRAWINGS

FIG. 1 is a schematic view of driving a typical capacitive touch panel;

FIG. 2 schematically illustrates the structure of a typical capacitive touch panel;

FIG. 3 is a schematic view of a typical capacitive touch panel without an approaching finger;

FIG. 4 is a schematic view of a typical capacitive touch panel with an approaching finger;

FIG. 5 is a schematic view of a system using detectable signals of panel for data communication according to an embodiment of the present invention;

FIG. 6 is a schematic view of another embodiment according to the invention;

FIG. 7 is a schematic view of still another embodiment according to the invention;

FIG. 8 is a schematic view of further another embodiment according to the invention;

FIG. 9 is a flowchart of a method using detectable signals of panel for data communication according to the invention;

FIG. 10 is a detailed flowchart of step (C) in the method using detectable signals of panel for data communication according to the invention; and

FIGS. 11 and 12 are schematic diagrams of packet formats according to the invention.

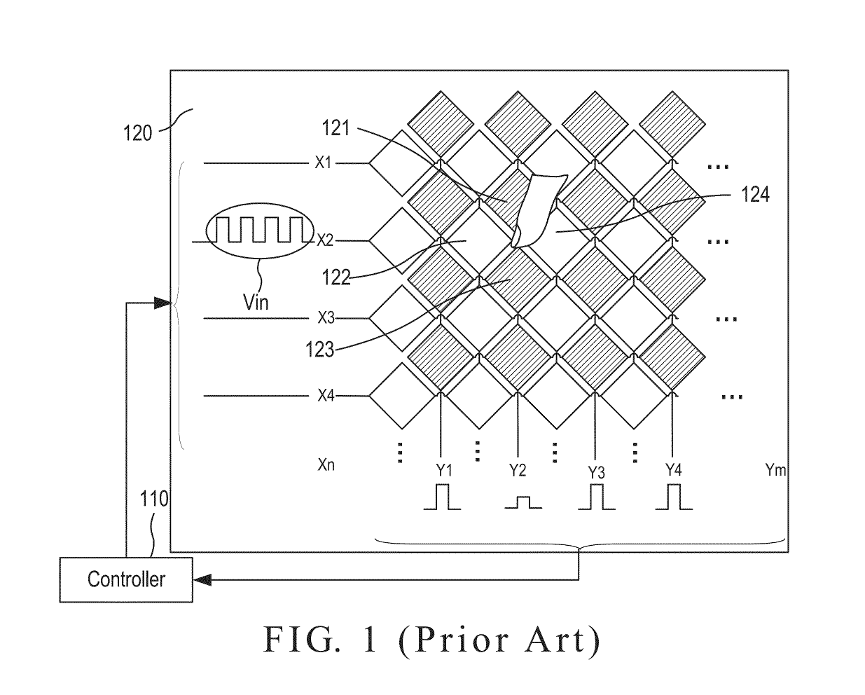

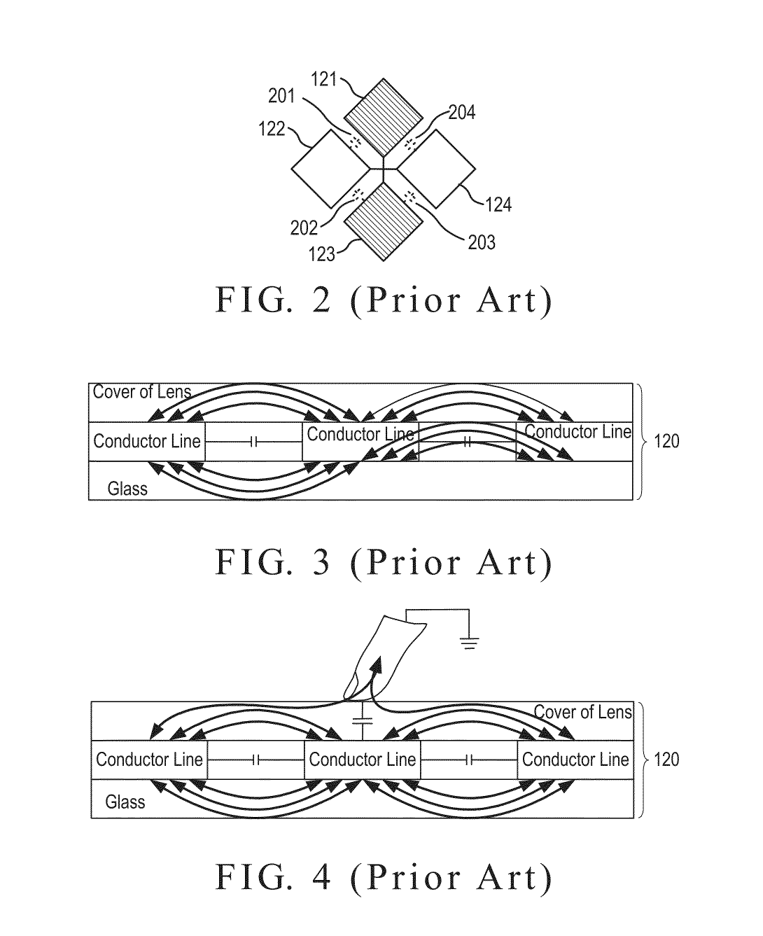

### DETAILED DESCRIPTION OF THE PREFERRED EMBODIMENT

The present invention provides a system and method using detectable signals of panel for data communication. The panel can be an LCD panel, a CRT screen, or a touch-control screen.

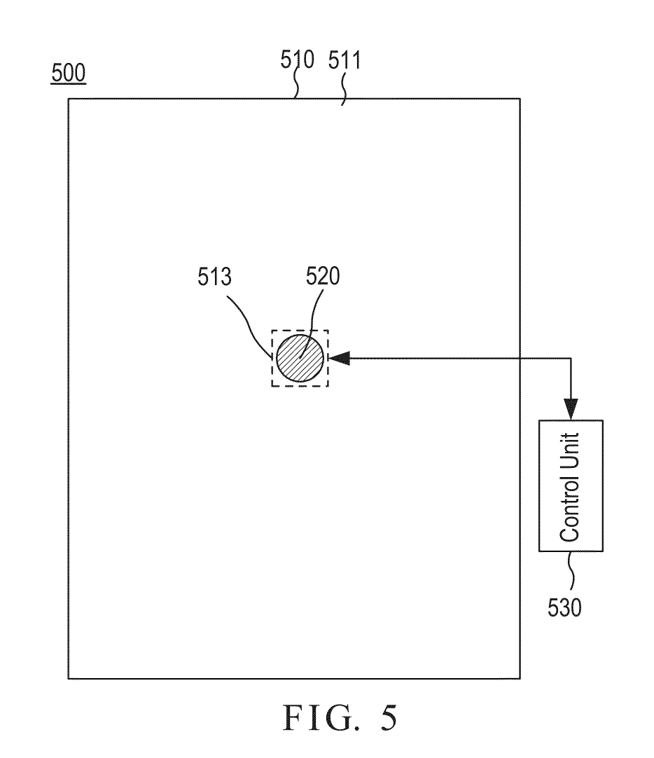

FIG. 5 is a schematic view of a system 500 using detectable signals of panel for data communication according to an embodiment of the present invention. The system 500 includes a panel 510, at least one detectable signal detector 520, and a control unit 530.

The panel 510 has a surface 511 for displaying an image. At least one area 513 of the surface 511 is used to display variation of a detectable signal.

The at least one detectable signal detector is coupled to the at least one area 513 for detecting the variation of the detectable signal in the at least one area 513 and producing a corresponding detection signal.

The control unit 530 is connected to the at least one detectable signal detector 520, wherein the detection signal generated by detecting the variation of the detectable signal in the area 513 represents a corresponding data state. Thus, the control unit 530 can obtain the data state sent from the at least one area.

When the detectable signal is a brightness signal, the detectable signal detector 520 can be one of a photodiode, photosensitive resistor, and optical switch.

When the detectable signal displayed in the area 513 is the brightness of the area 513, the detectable signal detector 520 is an optical detection circuit (e.g., a photodiode, a photosensitive resistor, an optical switch, and the like). In this case, the detectable signal detector 520 can detect the brightness of the area 513. For example, when a black/white picture is displayed in the area 513, it represents the logic value 0/1.

When the detectable signal is a gray level signal, the detectable signal detector 520 can be one of a photodiode, photosensitive resistor, and optical switch. The area 513 can display different gray levels to represent different logic combinations. For example, a four-scale gray level may represent the logic value 00/01/10/11; an eight-scale gray level may represent logic value 000/001/010/011/100/101/110/111; and so on.

The detectable signal detector 520 can be a CdS photosensitive resistor with a resistance range of about 2K Ω-20K Ω. In this case, the resistance value is about 2K Ω when a white picture displayed in the area 513 is detected, and is about 20K Ω when a black picture displayed in the area 513 is detected. Such a feature can be implemented as a photosensitive switch and connected to the general purpose input/output (GPIO) pins of the control unit 530 to thereby receive corresponding logic values, so as to achieve the data communication.

When the detectable signal is a color signal, the detector 520 is a color detector. Namely, when the detectable signal displayed in the area 513 is the color of the area 513, the detectable signal detector 520 is a color detection circuit, e.g., a color detector. The detectable signal detector 520 can identify different colors, such that the control unit 530 can decode them into different logic values. Thus, the data communication is achieved. For example, the black/white picture displayed on the display can represent the logic value 0/1, and/or the red/green/blue/white picture can represent the logic value 00/01/10/11, and so on.

For an example of a color detector using an I2C transmission interface, when it detects different colors of the display, the control unit 530 can read the transformed values of the three primary colors stored in the internal R/G/B registers of the color detector and accordingly determine the logic values representative of the colors of the area 513. Thus, the data communication is achieved.

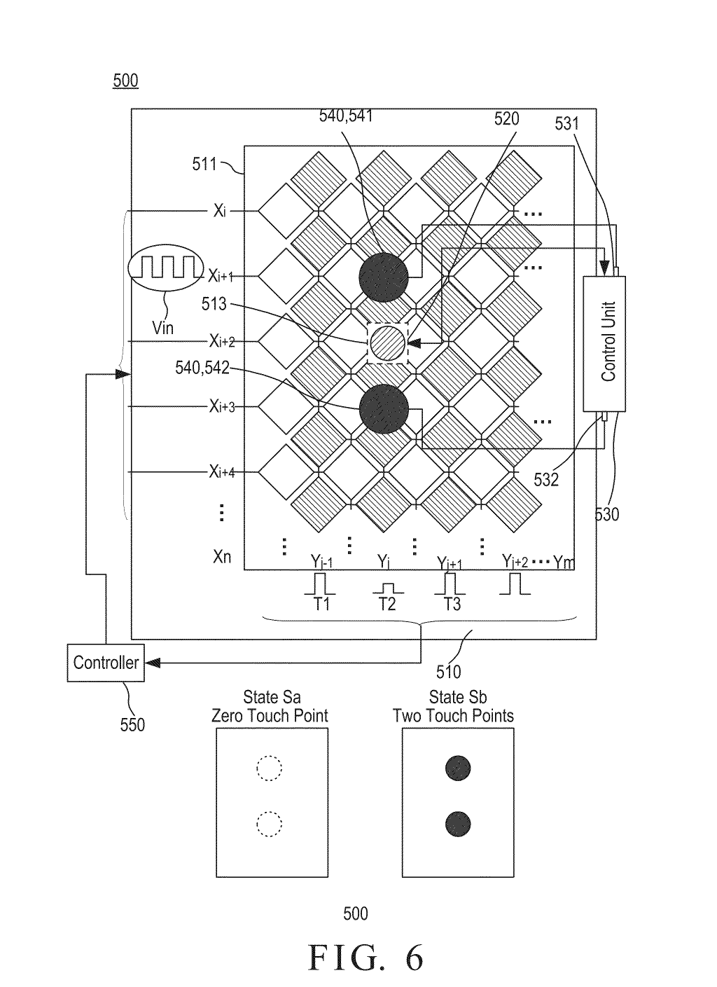

Therefore, as cited above, the present invention can use the detectable signals of the panel 510 for data communication. The present invention can also be applied to touch panels. FIG. 6 is a schematic view of another embodiment according to the invention. In FIG. 6, the panel 510 is a touch panel and further includes at least two conductive contacts 540 connected to the control unit 530 and mounted on the surface 511 to thereby locate the area 513.

The touch panel 510 has a controller 550. The surface 511 of the touch panel 510 is used to receive the touch points touched by the users' fingers or other objects. The controller 550 is electrically connected to the touch panel 510 for receiving the data of the touch points on the touch panel 510. Namely, the controller 550 is connected to the touch panel 510 in order to compute the coordinates of the conductive contacts 540 mounted on the touch panel 510 and accordingly compute the location of the area 513.

The controller 550 is based on the location of the area 513 to produce the variation of a detectable signal in the area 513.

The control unit 530 configures every two of the at least two conductive contacts 540 to be electrically connected or disconnected, such that the controller 550 can detect the coordinates of the at least two conductive contacts 540.

Since the control unit 530 configures every two of the at least two conductive contacts 530 to be electrically connected or disconnected, the touch panel 510 can detect different numbers of touch points corresponding to the at least two conductive contacts 540 for indicating a plurality of data states, thereby sending the plurality of data states to the controller 550.

As shown in FIG. 6, when the at least two conductive contacts 540 include two conductive contacts 541, 542 which are configured to be electrically connected or disconnected by the control unit 530, the coordinates of two touch points on the touch panel 510 can be detected, and the at least one area 513 is at the center of the two touch points.

As shown in FIG. 6, the conductive contact 541 is placed at the intersection of the conductor lines Xᵢ₊₁ and Yⱼ on the surface 511 and the conductive contact 542 is placed at the intersection of the conductor lines Xᵢ₊₃ and Yⱼ on the surface 511. When the control unit 530 configures the two conductive contacts 541, 542 to be electrically disconnected, no touch point on the touch panel 510 is detected, and in this case a first data state Sa is output. Conversely, when the control unit 530 configures the two conductive contacts 541, 542 to be electrically connected, two touch points on the touch panel 510 are detected, and in this case a second data state Sb is output.

When the two conductive contacts 541, 542 are electrically disconnected, they are floating and thus the power lines at the intersection of the conductor lines Xᵢ₊₁ and Yⱼ on the touch panel 510 are not reduced.

When the two conductive contacts 541, 542 are electrically connected, and the controller 550 produces a driving signal Vin on the conductor line Xᵢ₊₁, the conductor line Xᵢ₊₃ is at a low voltage such that the conductive contact 542 is virtually grounded, as shown by the principle of FIG. 4. Further, the conductive contact 541 is virtually grounded since the conductive contacts 541, 542 are electrically connected, such that the power lines at the intersection of the conductor lines Xᵢ₊₁ and Yⱼ on the touch panel 510 are relatively reduced. Accordingly, the controller 550 can detect a low voltage, i.e., a touch point positioned at the intersection of the conductor lines Xᵢ₊₁ and Yⱼ.

When the controller 550 produces a driving signal Vin on the conductor line Xᵢ₊₃, the conductive contact 541 is virtually grounded because the conductor line Xᵢ₊₁ is at the low voltage, and the conductive contact 542 is also virtually grounded since the conductive contacts 541, 542 are electrically connected, such that the power lines at the intersection of the conductor lines Xᵢ₊₃ and Yⱼ on the touch panel 510 are reduced. Accordingly, the controller 550 can detect a low voltage, i.e., another touch point positioned at the intersection of the conductor lines Xᵢ₊₃ and Yⱼ.

The control unit 530 is preferably a micro control unit (MCU) with two general purpose input/output (GPIO) pins 531, 532. The two GPIO pins 531 and 532 are connected to the two conductive contacts 541 and 542 respectively. When the two GPIO pins 531, 532 output a low voltage, the control unit 530 is conducted, and the two conductive contacts 541 and 542 are electrically connected. When the GPIO pins 531, 532 do not output a low voltage, the control unit 530 is not conducted, and the two conductive contacts 541 and 542 are electrically disconnected.

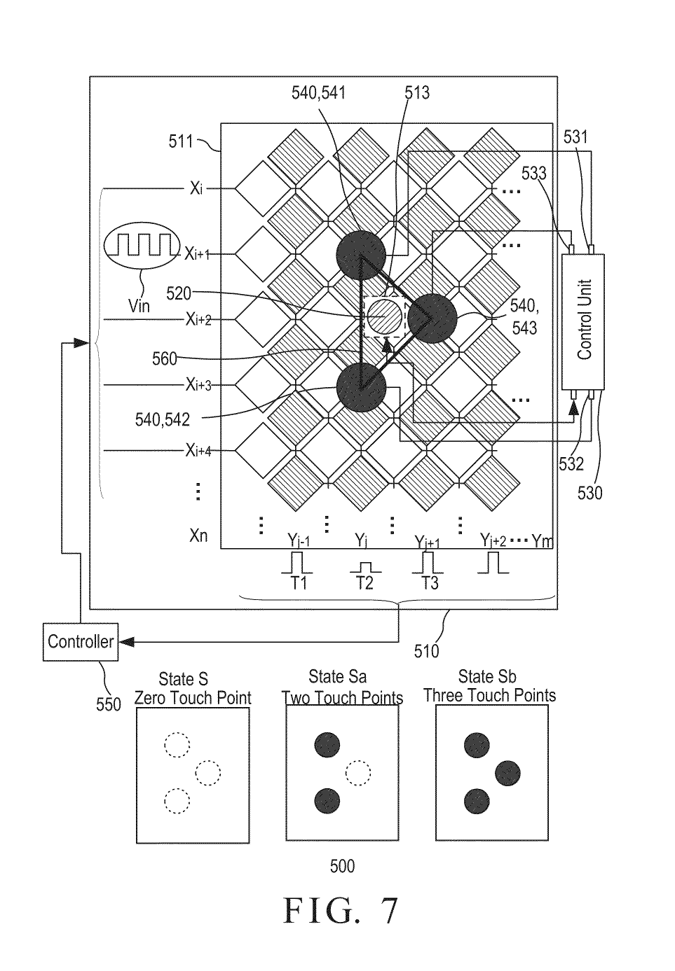

FIG. 7 is a schematic view of still another embodiment according to the invention. In FIG. 7, the at least two conductive contacts 540 include three conductive contacts 541, 542, 543. The coordinates of three touch points on the touch panel 510 can be detected by configuring every two of the three conductive contacts 541-543 to be electrically connected or disconnected by the control unit 530, and the at least one area 513 is at the center of the three touch points.

As shown in FIG. 7, when the at least two conductive contacts 540 include the three conductive contacts 541-543, the control unit 530 can configure every two of the three conductive contacts 541-543 to be electrically disconnected, such that no touch point on the touch panel 510 can be detected, and in this case a start state S is output. When the control unit 530 configures only two of the three conductive contacts 541-543 to be electrically connected, two touch points on the touch panel can be detected, and in this case a first data state Sa is output. When the control unit 530 configures all the three conductive contacts 541-543 to be electrically connected to one another, three touch points on the touch panel can be detected, and in this case a second data state Sb is output. The three conductive contacts 541-543 form a triangle 560 on the surface 511 of the touch panel 510.

The control unit 530 is preferably a micro control unit (MCU) with three general purpose input/output (GPIO) pins 531, 532, 533 connected to the three conductive contacts 541, 542, 543 respectively. In other embodiments, a ground pin of the MCU 530 can be used.

When the three GPIO pins 531-533 are floating, every two of the three conductive contacts 541-543 are electrically disconnected, such that no touch point on the touch panel 510 is detected. When two of the three GPIO pins 531-533 output a low voltage, the two conductive contacts corresponding to the two GPIO pins are electrically connected, and two touch points on the touch panel 510 are detected. When all the three GPIO pins 531-533 output the low voltage, the three conductive contacts are electrically connected to one another, and three touch points on the touch panel 510 are detected.

As shown in FIG. 7, the at least one area 513 is disposed in the triangle 560. The controller 550 displays different brightness or colors for the area 513 to thereby send the data to the control unit 530. The controller 550 can detect the positions of the three conductive contacts 541-543 to accordingly determine the location of the triangle 560 and further determine the at least one area 513.

Since the touch panel 510 is typically located on a display panel (not shown), the controller 550 can drive the display panel corresponding to the location of the area 513 to display the different brightness or colors, such that the surface 511 can display the different brightness or colors, and the at least one detectable signal detector 520 can detect the different brightness or colors displayed on the surface 511 to thereby produce the corresponding data states, such as logic 0 and logic 1. Thus, the controller 550 can send the data to the control unit 530.

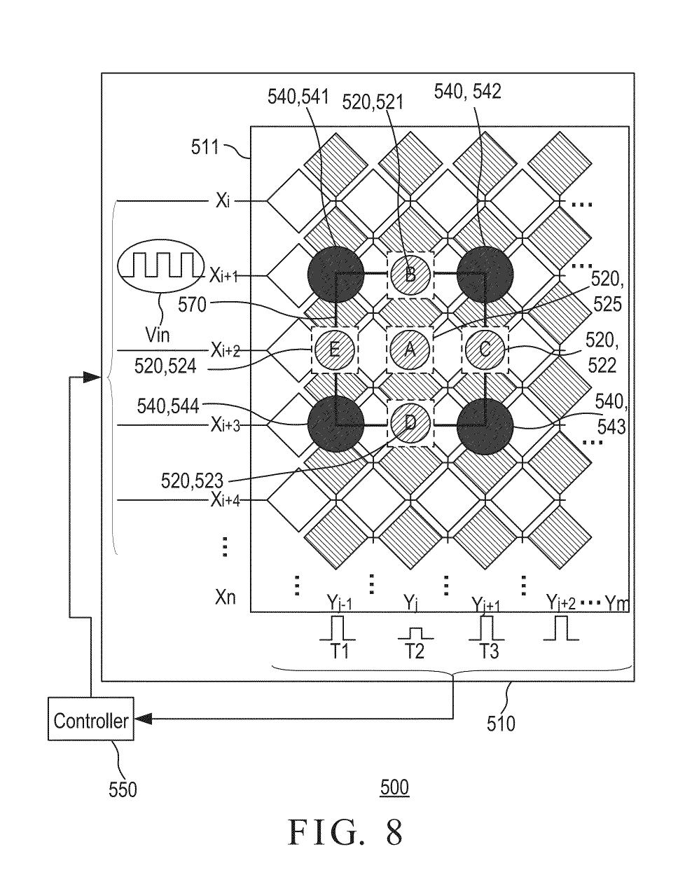

FIG. 8 is a schematic view of further another embodiment according to the invention. In FIG. 8, the at least two conductive contacts 540 include four conductive contacts 541, 542, 543, 544. The control unit 530 can configure every two of the four conductive contacts 541-544 to be electrically connected or disconnected to thereby detect the coordinates of four touch points on the touch panel 510, and the at least one area 513 is at the center of the four touch points and at each center of two touch points corresponding to every two of the four conductive contacts 541-544 that are electrically connected. As shown in FIG. 8, the at least one area 513 includes five locations respectively disposed at the center of the four touch points and each center of every two adjacent touch points. In this case, the at least one detectable signal detector 520 includes five photo or color detection circuits 521-525.

When the controller 550 detects the position of the detectable signal detector 520, it can control the brightness and/or color variation of the five blocks A/B/C/D/E, as denoted in FIG. 8, to thereby send the data, and the detectable signal detector 520 can use a brightness and/or color detection element to receive the data. For implementing a synchronous parallel transmission, a signal caused by the brightness and/or color variation of the block A is defined as a synchronous signal while signals caused by the brightness and/or color variation of the blocks B/C/D/E are defined as data signals.

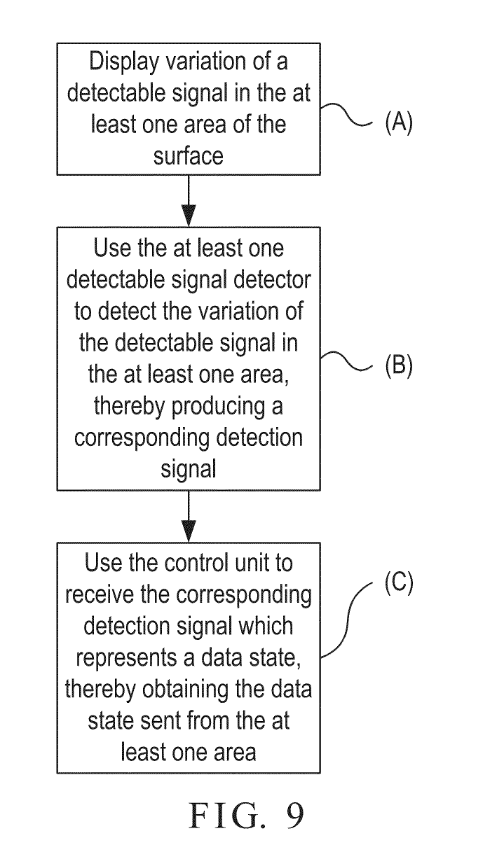

FIG. 9 is a flowchart of a method using detectable signals of a panel for data communication according to the present invention. As shown in FIG. 9 as well as FIG. 5, the method is used in the panel 510. The panel 510 has a surface 511 for displaying an image. At least one detectable signal detector 520 is coupled to the at least one area 513 of the surface 511. A control unit 530 is connected to the at least one detectable signal detector 520. In step (A), the variation of a detectable signal is displayed in the at least one area 513 of the surface 511. In step (B), the at least one detectable signal detector 520 detects the variation of the detectable signal in the at least one area 513, thereby producing a corresponding detection signal. In step (C), the control unit 530 receives the detection signal which represents a corresponding data state, thereby obtaining the data state sent from the at least one area.

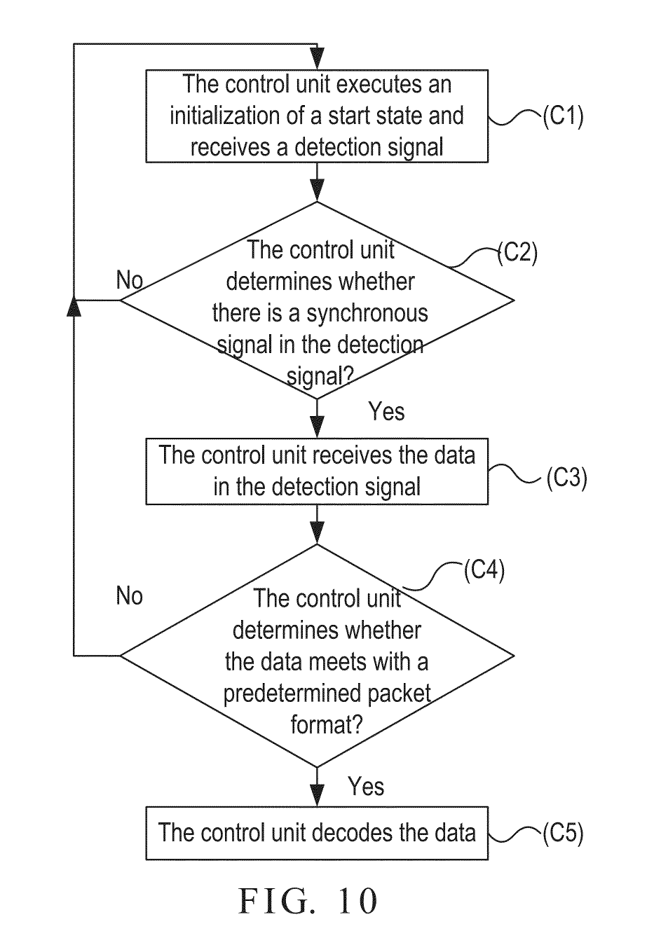

FIG. 10 is a detailed flowchart of step (C). In step (C1), the control unit 530 executes an initialization of a start state and receives the detection signal. In step (C2), the control unit 530 determines whether there is a synchronous signal in the detection signal.

In step (C3), when it determines that there is a synchronous signal in the detection signal, the control unit 530 receives the data in the detection signal. When step (C2) determines that there is no synchronous signal in the detection signal, step (C1) is executed.

In step (C4), the control unit 530 determines whether the data meets with a predetermined packet format. In step (C5), the control unit 530 decodes the data when it determines that the data meets with the packet format; otherwise step (C1) is executed.

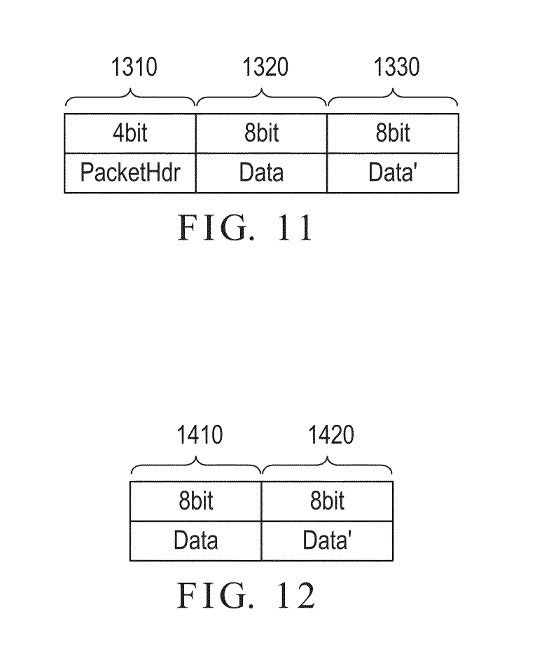

In FIGS. 6 and 7, the at least one detectable signal detector 520 has one detector only, and thus an asynchronous transmission is used, with a packet format shown in FIG. 11. The packet format includes the first four bits to indicate a packet header 1310 as the start of the packet, the following eight bits to indicate a data field 1320, and a check field 1330 after the data field 1320. The check field 1330 can be a cycle redundancy check (CRC) or a complement DATA′ of the data field 1320. If the data 0x55 is transmitted, when the check field 1330 is the complement of the data field 1320, the complete packet has a content of:

1010_{b}(sync)+01010101_{b}(Data)+10101010_{b}(Data′).

In FIG. 8, the at least one detectable signal detector 520 has five photo and/or color detection circuits 521, 522, 523, 524, 525. When a signal caused by the brightness and/or color variation of the block A is defined as a synchronous signal, i.e., the signal received by the photo and/or color detection circuit 525 is regarded as a clock signal, a synchronous transmission can be achieved, and the signals received by the detection circuits 521, 522, 523, 524 directly produce a data packet with a packet format shown in FIG. 12. The packet format includes the first eight bits to indicate the data field 1410 and the eight bits after the data field 1410 to indicate the check field 1420. The check field 1420 can be a cycle redundancy check (CRC) or a complement DATA′ of the data field 1410. If the data 0x55 is transmitted, when the check field 1420 is the complement of the data field 1410, the complete packet has a content of:

01010101_{b}(Data)+10101010_{b}(Data′).

As cited, the panel in the prior art is used to produce a display image, and the touch panel is used to receive one or more touch points. However, the present invention uses the control unit 530 to switch every two of the at least two conductive contacts to be electrically connected or disconnected, such that the touch panel 510 can further detect different touch point numbers corresponding to the at least two conductive contacts 540. When the controller 550 detects the location of the at least one detectable signal detector 520, it can control the brightness and/or color variation of the at least one area 513 to thereby send the data. Thus, the control unit 530 uses the at least one detectable signal detector 520 to detect the signals corresponding to the brightness and/or color variation of the at least one area 513. Namely, the panel in the invention is used as a communication medium which allows the handheld touch-control devices without a USB, SD, and Bluetooth to transmit/receive data to/from the peripherals. In addition, the control unit 530 can be a microcontroller, such as 8051, with the GPIO pins, so that the hardware and cost required for data transfer is relatively reduced.

Although the present invention has been explained in relation to its preferred embodiment, it is to be understood that many other possible modifications and variations can be made without departing from the spirit and scope of the invention as hereinafter claimed.

What is claimed is:

1. A system using detectable signals of panel for data communication, comprising:
a panel having a surface for displaying an image, wherein at least one area of the surface is used to display variation of a detectable signal;
at least one detectable signal detector coupled to the at least one area for detecting the variation of the detectable signal in the at least one area and producing a corresponding detection signal; and
a control unit connected to the at least one detectable signal detector for receiving the detection signal,
wherein the detection signal produced from detecting the variation of the detectable signal in the at least one area represents a corresponding data state, so as to obtain the data state sent from the at least one area.

2. The system as claimed in claim 1, wherein the panel is a touch panel and the system further comprises at least two conductive contacts electrically connected to the control unit and mounted on the touch panel, thereby positioning the at least one area.

3. The system as claimed in claim 2, wherein the touch panel comprises a controller connected to the touch panel for computing coordinates of the at least two conductive contacts mounted on the touch panel and accordingly computing a location of the at least one area.

4. The system as claimed in claim 3, wherein the control unit configures every two of the at least two conductive contacts to be electrically connected, such that the controller detects the coordinates of the at least two conductive contacts.

5. The system as claimed in claim 4, wherein the at least two conductive contacts include two conductive contacts and the control unit configures the two conductive contacts to be electrically connected, so that coordinates of two touch points on the touch panel are detected and the at least one area is at a center of the two touch points.

6. The system as claimed in claim 4, wherein the at least two conductive contacts include three conductive contacts and the control unit configures every two of the three conductive contacts to be electrically connected, so that coordinates of three touch points on the touch panel are detected and the at least one area is at a center of the three touch points.

7. The system as claimed in claim 4, wherein the at least two conductive contacts include four conductive contacts and the control unit configures every two of the four conductive contacts to be electrically connected, so that coordinates of four touch points on the touch panel are detected and the at least one area is at a center of the four touch points and at each center of every two adjacent touch points.

8. The system as claimed in claim 4, wherein the controller is based on location of the at least one area to produce the variation of the detectable signal in the at least one area.

9. The system as claimed in claim 8, wherein the detectable signal is a brightness signal, and the at least one detectable signal detector is one of photodiode, photosensitive resistor, and optical switch.

10. The system as claimed in claim 8, wherein the detectable signal is a gray level signal, the detectable signal detector is one of photodiode, photosensitive resistor, and optical switch.

11. The system as claimed in claim 8, wherein the detectable signal is a color signal, the detectable signal detector is a color detector.

12. A method using detectable signals of panel for data communication, which is applied in a panel including a surface for displaying an image, at least one detectable signal detector coupled to at least one area of the surface, and a control unit connected to the at least one detectable signal detector, the method comprising the steps of:
(A) displaying variation of a detectable signal in the at least one area of the surface;
(B) using the at least one detectable signal detector to detect variation of the detectable signal in the at least one area, thereby producing a corresponding detection signal; and
(C) using the control unit to receive the detection signal which represents a corresponding data state, so as to obtain the data state sent from the at least one area.

13. The method as claimed in claim 12, wherein step (C) comprises:
(C1) using the control unit to execute an initialization of a start state and receive the detection signal;
(C2) using the control unit to determine whether there is a synchronous signal in the detection signal;
(C3) using the control unit to receive data in the detection signal when the synchronous signal in the detection signal is determined and received;
(C4) using the control unit to determine whether the data meets with a predetermined packet format; and
(C5) using the control unit to decode the data when the data meets with the predetermined packet format.

14. The method as claimed in claim 13, wherein step (C1) is executed when the control unit in step (C2) determines that there is no synchronous signal in the detection signal.

15. The method as claimed in claim 13, wherein step (C1) is executed when the control unit in step (C4) determines that the data does not meet with the predetermined packet format.
